(19) United States
(12) Patent Application Publication
(10) Pub. No.: US 2018/0032991 A1
(43) Pub. Date: Feb. 1, 2018

(54) SYSTEM AND METHOD FOR PROVIDING A PLATFORM FOR SENSING GROCERY ITEMS AND GENERATING A DATA LIST OF THE GROCERY ITEMS

(71) Applicant: Kara Scanlin, Chicago, IL (US)

(72) Inventor: Kara Scanlin, Chicago, IL (US)

(21) Appl. No.: 15/657,322

(22) Filed: Jul. 24, 2017

Related U.S. Application Data
(60) Provisional application No. 62/367,086, filed on Jul. 26, 2016.

(51) Int. Cl. G06Q 20/20; G06Q 30/06; G07G 1/00

(52) U.S. Cl. CPC G06Q 20/208; G07G 1/0054; G06Q 20/203; G06Q 30/0633

(57) ABSTRACT

A method for providing a platform for sensing grocery items and generating a data list of the grocery items is disclosed. The method comprise storing, in an item inventory database in a central system, a plurality of grocery items of an inventory and a plurality of codes associated with the plurality of grocery items of the inventory, respectively; storing one or more lists of a grocery items of the user in a user list of grocery items database on the central system, generating an ID associated with the sensor device; sensing, by a sensor device, a grocery item and identifying a code associated with the grocery item, wherein sensing includes automatically activating the sensor device in response to a signal from a scan of the item or audio representing the item sensed; comparing the code associated with the item to the plurality of codes stored in the item inventory database to determine if the item is matched to items in the item inventory database, and storing the item in the user list of grocery items database as part of the user's list of grocery items if a match is determined.

### CROSS REFERENCE TO RELATED APPLICATIONS

This application claims priority to U.S. provisional application No. 62/367,086, filed on Jul. 26, 2016 entitled “System and Method For Providing a Platform For Sensing Grocery Items and Generating a Data List of the Grocery Items” which is incorporated by reference herein.

### FIELD OF THE INVENTION

The present invention relates to a system and method for providing a platform for sensing grocery items and generating a data list of the grocery items.

### BACKGROUND OF THE INVENTION

Consumers typically make frequent trips to the grocery store to shop for grocery and home consumable items. A typical consumer visit involves randomly roaming the isles for desired items. Today, most consumers still rely on pen and paper to make a list of needed items. There are, however, several problems with paper lists. First, consumers either misplace their lists or unintentionally leave their lists at home. As a result, the consumer fails to remember items for purchase, and often times, must return to the store to obtain the forgotten items. Both time and money are wasted in the process (e.g., making the extra trips). Second, the list is often disorganized, making it difficult to navigate the isles of the grocery store. In addition, it takes too much time to maintain and organize these lists.

For many of these reasons, consumers are turning to online shopping and delivery for many home consumable items. Today, about one to six percent of grocery items are purchased online. Brick and mortar retailers (such as grocery stores) are in jeopardy of losing significant amounts of revenue (projections are up to twenty percent of revenue by year 2020) to online shopping and delivery for home consumables and grocery items. Some of these retailers now offer web-based and mobile applications for consumers to generate a list online or through the use of their mobile device for online shopping and pick-up or delivery. Consumers have not embraced these new technologies to interact with their grocer as rapidly as the retailer would like, in part because of the time consuming process of curating a list though a mobile application or web-based application. Grocers are seeking ways to retain customers and enhance the relationship with their consumers—part of the relationship that they are losing when consumers order home consumables and grocery items directly from online platforms and bypass the grocer. Furthermore, consumer packaged goods companies rely on old methods of shopping through retailers as parts of their process to engage with their customers.

### SUMMARY OF THE INVENTION

A system and method are disclosed for providing a platform for sensing grocery items and generating a data list of the grocery items.

In accordance with an embodiment of the present disclosure, a method for providing a platform for sensing grocery items and generating a data list of the grocery items is disclosed. The method comprise storing, in an item inventory database in a central system, a plurality of grocery items of an inventory and a plurality of codes associated with the plurality of grocery items of the inventory, respectively; storing one or more lists of a grocery items of the user in a user list of grocery items database on the central system, generating an ID associated with the sensor device; sensing, by a sensor device, a grocery item and identifying a code associated with the grocery item, wherein sensing includes automatically activating the sensor device in response to a signal from a scan of the item or audio representing the item sensed; comparing the code associated with the item to the plurality of codes stored in the item inventory database to determine if the item is matched to items in the item inventory database; and storing the item in the user list of grocery items database as part of the user's list of grocery items if a match is determined.

In accordance with yet another embodiment of this disclosure, a system is disclosed for providing a platform for sensing grocery items and generating a data list of the grocery items, the system comprising: (a) one or more servers configured to store (i) an item inventory database of a plurality of grocery items of an inventory and a plurality of codes associated with the plurality of grocery items of an inventory of grocery items and (ii) a user list of grocery items database of one or more lists of a grocery items of the user; and (b) a sensor device configured to sense a grocery item and identify a code associated with the grocery item, the sensor device further configured to automatically activate in response to signal from a scanner within the sensor device of the scanned grocery item or sound from a user representative of the grocery item; wherein the one or more servers further configured to communicate with the sensor device, the one or more servers are programmed to execute method steps, the method steps comprising: (1) generating an ID associated with the sensor device; (2) comparing the code to the plurality of codes stored in the item inventory database to determine if the item is matched to items in the item inventory database; and (3) adding the item to the user list of grocery items database as part of the user's list of grocery items if a match is determined.

### BRIEF DESCRIPTION OF DRAWINGS

FIG. 1 depicts a block diagram of an example system in which a platform for sensing grocery items and generating a data list of the grocery items operates.

FIG. 2 depicts a block diagram of the components of the sensor device of FIG. 1.

FIG. 3 depicts certain applications/modules and databases of the platform for sensing grocery items and generating a data list of the grocery items.

FIG. 4 depicts method steps for creating a data inventory of grocery items associated with the platform for sensing grocery items and generating a data list of the grocery items.

FIG. 5 depicts certain method steps associated with the platform for sensing grocery items and generating a data list of the grocery items.

FIG. 6 depicts method steps associated with the sensing and processing of grocery items in connection with the platform for sensing grocery items and generating a data list of the grocery items.

FIG. 7 depicts method steps of a grocery store in connection with the platform for sensing grocery items and generating a data list of the grocery items.

### DETAILED DESCRIPTION OF THE INVENTION

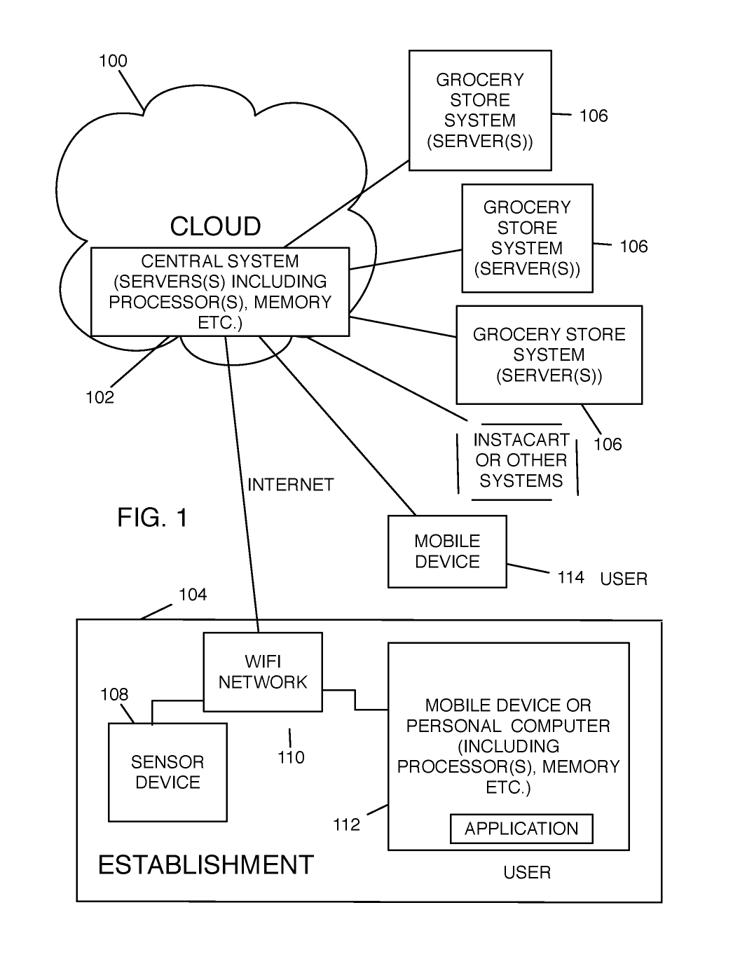

FIG. 1 depicts a block diagram of an example system 100 in which a platform (discussed in detail below) for sensing grocery items and generating a data list of grocery items operates. Specifically, this platform enables a user to select items for and create a data list of such items that are grouped in isles or categories for shopping efficiency. These items may be grocery store items or other items such as hospital, beauty and/or other user consumable items known to those skilled in the art. For purposes of the discussion herein, grocery store items are used.

System 100 includes central system 102 and residence 104 that is configured to access program modules/applications and data (as described below) from central system 102 via a network such as the Internet. Central system 102 is shown in FIG. 1 in the cloud, as known to those skilled in the art. Establishment 104 may communicate with central system 102 over a network, such as the Internet, via a wired connection (e.g., cable, Ethernet) or wirelessly (e.g., WIFI or wireless carrier networks) as known to those skilled in the art. An administrator may access central system 102 through a connected client (not shown) to control the operation of the platform for sensing grocery items and generating a data list of the grocery items. This client may be on site or remotely connected to central system 102 over the Internet and/or local area network (LAN). The client may be a personal computer (e.g., desktop or laptop) or display or a mobile device.

Central system 102 comprises one or more servers that are typically connected via a local area network (LAN). The one or more servers may include a web server. Each server includes several internal components (e.g., processor, memory, drives, storage such as hard drives/SSDs, network cards, video cards etc.), operating system, databases, software modules and applications (e.g., browser) as known to those skilled in the art. Central system 102 is configured to communicate with one or more grocery store systems 106 (or systems such as an e-commerce systems, e.g., Instacart and MyWebGrocer, as shown in dashed lines in FIG. 1.). Examples of grocery store systems include Whole Foods, Mariano's, Jewel and Safeway (to name a few).

Establishment 104 may be residence (e.g., a home, condominium, townhouse), business/venue or any other place where food (or other items) is stored for user consumption. Establishment 104 comprises, among other components, sensor device 108 and WIFI network 110. Establishment 104 also depicts mobile device or personal computer 112. However, a user may roam with the mobile device 112 on and off the establishment 108 premises as known to those skilled in the art. System 100 also includes mobile device 114. Users (also referred to as consumers) employ mobile devices 112 and 114 to access the platform for sensing grocery items and generating a data list of the grocery items (e.g., add items to the list by text directly and/or by scanned barcodes via mobile devices 112 and 114). WIFI network 110 is a communication that enables wireless communication to other computers, devices and networks as known to those skilled in the art.

Mobile device or personal computer each includes several internal components (e.g., processor, memory, drives, storage such as hard drives/SSDs, network cards, video cards etc.), operating system, databases, software modules and applications (e.g., browser) as known to those skilled in the art. Mobile device or personal computer 114, as known to those skilled in the art, incorporates several applications, one of which is used to access modules and features of modules and databases of platform sensing grocery items and generating a data list of the grocery items.

Sensor device 108 is connected to central system 102 wirelessly via WIFI network 110 or wired connection (not shown). Mobile device 112 also connects wirelessly via WIFI network 110 or a wired connection (not shown). Sensor device 108 is configured to sense voice (audio) signals or sense an item moved within a certain proximity of sensor device 108. Once a signal is detected, sensor device 108 activates (turns on) to process the signal. This is described in detail below.

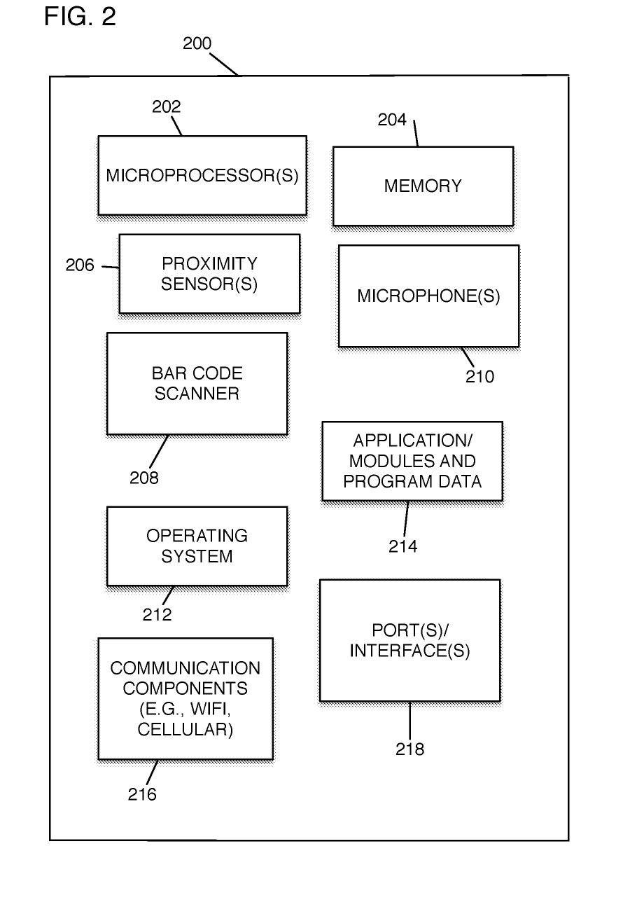

FIG. 2 depicts a block diagram of the components of the sensor device 108 of FIG. 1, but renumbered as sensor device 200 in FIG. 2. Sensor device 200 comprises one or more processors 202, memory 204, proximity sensor(s) 206, barcode scanner 208, microphone(s) 210, operating system 212, application/modules 214, communication components 216 and port(s)/interface(s) 218.

Microprocessor(s) 202, as known to those skilled in the art, are configured to process signals and/or access modules and data from central system 102 as discussed in more detail below. In one example, one or more microprocessor(s) 202 are employed to process data received from barcode scanner 206 and/or microphones 208 and transmit processed data to central system 102. In particular, a first microprocessor may be configured to detect (listen to) audio, and immediately activate a second microprocessor (also referred to as a host) as well as a second microphone to receive and record the audio detected, and thereby temporarily cause the storage thereof in memory 204 before it is transmitted to central system 102.

Memory 204, as known to those skilled in the art, is a device configured for storing data.

Proximity sensor(s) 206 is a sensor able to detect the presence of objects nearby without any physical contact. Proximity sensor(s) 206 are employed to sense a grocery store item within a distance of sensor device 200 (and thereby activate the barcode scanner 208, via communication through microprocessor(s) 202). As discussed above, items other than grocery store items may be used for the platform described herein such as health and beauty items, beer/wine and/or other household goods.)

Barcode scanner 208, as known to those skilled in the art, is a device configured to read printed barcodes, translate barcodes to a numeric code and then output the numeric code to computer. Scanner 208 also includes decoder circuitry for analyzing the barcode's image data provide by the sensor and sending the barcode content to the scanner's output port. Marson Corporation manufactures many barcode scanners used for this purpose. Marson MT710B is an example of one of them.

Microphone(s) 210, as known to those skilled in the art, are used to receive and subsequently detect audio.

Operating system 212 is a variant of Linux but those skilled in the art know that any other operating system may be used to achieve desired results.

Application/modules and program data 214 comprise the application/modules as part of the platform sensing grocery items and generating a data list of as well as data items received and transmitted to central system 102 in connection with the platform.

Communication components 216, as known to those skilled in the art, include modems, routers and other devices used to enable communication wireless (e.g., WIFI, Zigbee, cellular) and wired communication with central system 102.

Port(s)/interface(s) 218, as known to those skilled in the art, are ports, jacks and interfaces used to enable wired connection to computers and/or peripherals, if desired.

Sensor device 200 may further include an AC/DC concerting circuit to enable device 200 to be plugged into an outlet in a wall. A battery may also be included for remote placement. Sensor device 200 may also include a buzzer or light (e.g., LED) for notifying a user that an item scanned or voice recognized signal has been matched in central system 102.

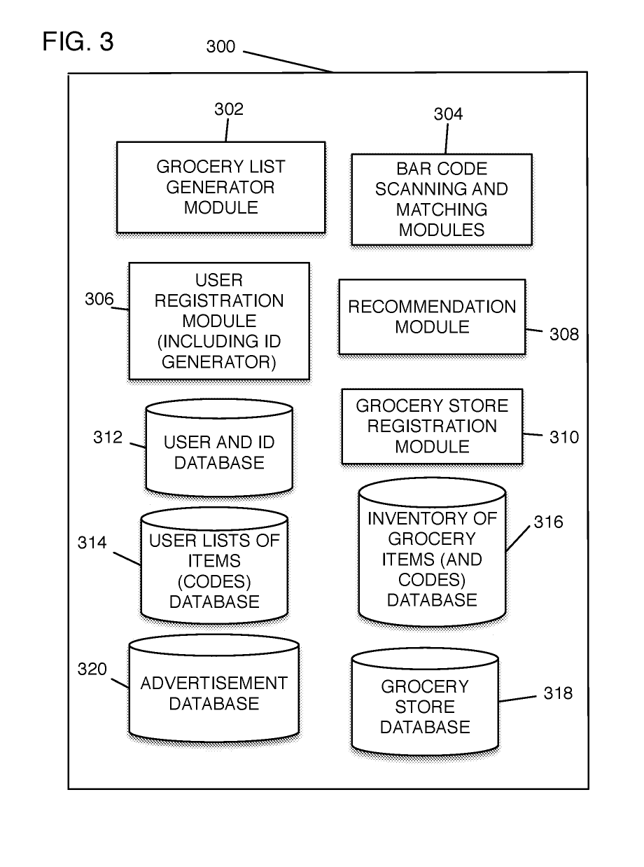

FIG. 3 depicts certain software modules/applications and databases of platform 300 for sensing grocery items and generating a data list of the grocery items. In particular, platform 300 comprises software application(s) modules such as grocery list generator 302, bar code scanning and matching modules 304, user registration module 306, recommendation module 308, grocery store registration module 310. Platform 300 further comprises several databases including user and ID database 312, user list of items database 314, inventory of grocery items database 316, grocery store database 318 and advertisement database 320.

Grocery list generator 302 is configured to generate a user-selected list of grocery data items that are assigned to isles or categories for user to subsequently employ for shopping efficiency.

Bar code scanning and matching modules 304 are modules configured to scan a barcode and transmit the resulting code to central system 102. The matching engine module will receive the decoded bar code data and match it with actual grocery data items stored in grocery data items database 316.

User registration module 306 is configured to enable users to register and use platform 300. User registration module 306 is also configured to generate a user identification (ID) that is associated with user selected grocery items. User registration module 306 may be used, or another module may be employed, to link sensor device(s) 108 (200) subsequently obtained and used. The ID may then be matched with subsequently obtained sensor device(s) 108 (200).

Recommendation module 308 is configured to provide data item recommendations to a user for his/her list based on user history of selected data items for a grocery list as well as data items actually purchased.

Grocery store registration module 310 is configured to enable a grocery store to register with platform 300 so that a grocery store may access modules and data from platform 300.

User and ID database 312, as known to those skilled in the art, is a database of user registration data along with user IDs that are associated with zero (e.g., those checking the platform) or one or more user sensor devices 108 (200, for creating a user grocery list of data items).

User lists of items database 314, as known to those skilled in the art, is a database of user lists of items (selected by users) for subsequent purchase. The items are associated with a list of codes (also stored in this database). The code may be in any number of formats such as UPC or standard text. The list is associated with a user ID.

Inventory of grocery items database 316, as known to those skilled in the art, is a database of grocery items (total inventory). The items are associated with codes (as described above) which are also stored in this database (e.g., UPC, text and/or other code known to those skilled in the art).

Grocery store database 318, as known to those skilled in the art, is a database of grocery stores along with their inventory of items and the location (i.e., isle) of such inventory items. Platform 300 will match the grocery store data items with a user's list of data items to advise a user of item availability and location. The grocery stores may or may not be registered.

Advertisement database 314 is a database, as known to those skilled in the art, is a database configured to store advertisements that registered advertisers have provided. Platform 300 will automatically apply advertisements as part of the user experience.

There may be other databases as known to those skilled in the art such as a favorite data items database for storing a user's favorite items.

Platform 300 may also access data from a grocery store POS (point of sale), inventory system or other system that stores products a store carries).

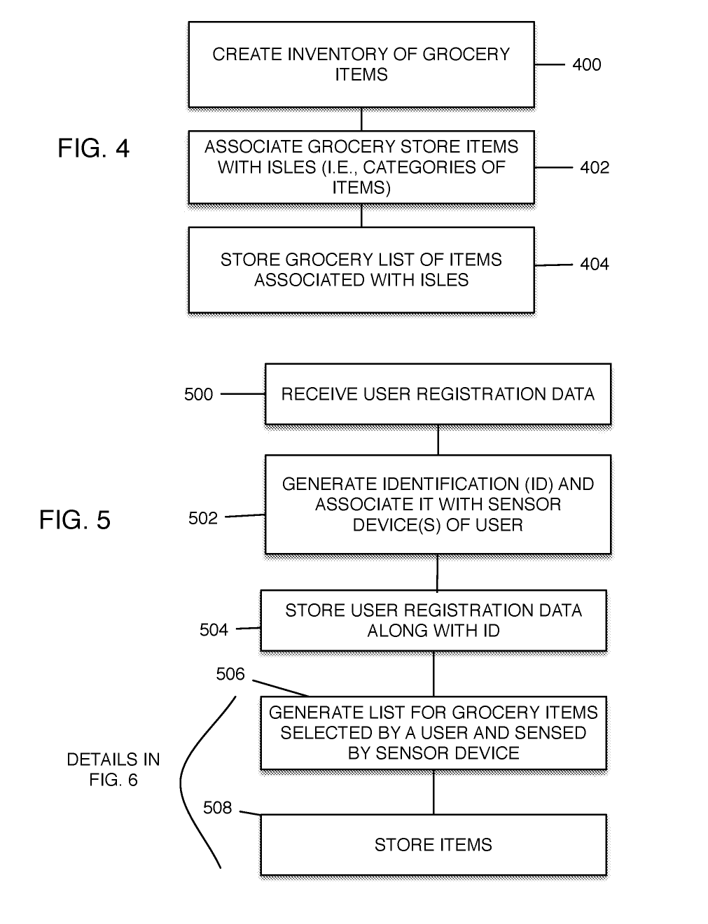

FIG. 4 depicts certain method steps for creating an inventory of grocery data items associated with the platform 300 for sensing grocery items and generating a data list of the grocery items. In particular, execution begins at step 400 wherein an inventory of grocery data items is created. In this respect, an administrator or other operator will create an inventory of items for one or more users to subsequently select for inclusion in their data list of items. Execution proceeds to step 402 wherein each item of the inventory of items is associated with (assigned to) an isle in a grocery store. The isle is essentially a category of items. For example, bananas will be assigned to a produce isle or category. The same applies to all fruits and vegetables. Execution then proceeds to step 404 wherein the inventory of items along with associated isles are stored inventory items database.

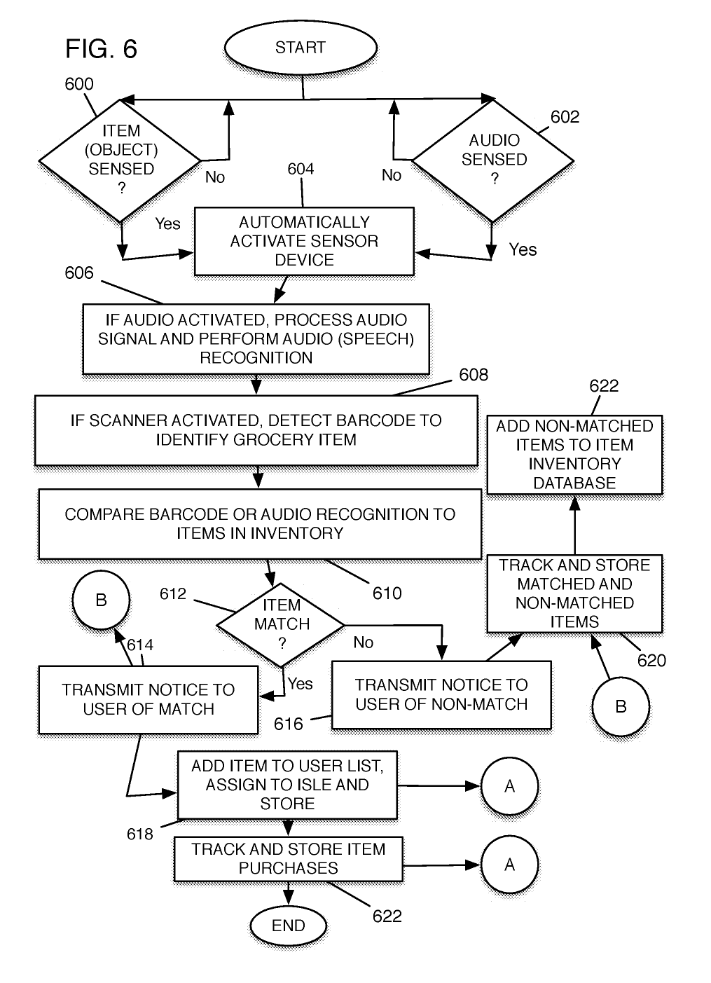

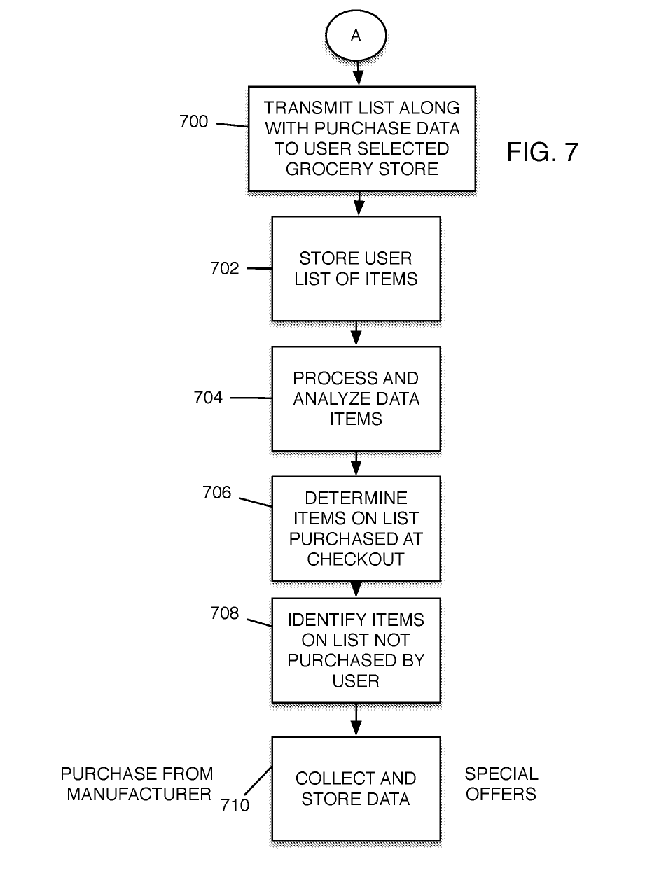

FIG. 5 depicts certain method steps for registering a user in connection with platform 300 for sensing grocery items and generating a data list of the grocery items. In particular, execution begins at step 500 wherein user registration data is received such as user name, email address, zip code, preferred grocery stores, brands and items etc. Execution proceeds to steps 502 and 504 wherein an identification (ID) code is assigned or associated with the user sensor device(s) 108 (200), if available, and the user registration data along with the user ID are stored in the user and ID database. Then execution proceeds to steps 506 and 508 where a user will generate a list of grocery items that are sensed by sensor device 108 (200) (or inputted by a user via mobile device 114) and stored in user list of items database 312. These steps are shown in detail in FIGS. 6-7 and described below.

FIG. 6 depicts method steps associated with the sensing and processing grocery items in connection with platform for sensing grocery items and generating a data list of the grocery items. In particular, execution begins at either decision step 600 or 602 wherein an item is sensed by the barcode scanner or audio (user voice) is sensed by an audio sensor (microphones and microprocessors). If an item or audio representing the item is sensed, in either case, execution proceeds to step 604 wherein the sensor device is automatically activated. Then execution proceeds to steps 606 and 608 wherein the audio is processed and audio recognition (speech to text) is performed (if audio is actually detected) or a barcode is detected and processed. (the barcode or text may be referred to as code herein.) Execution then proceeds to decision step 610 wherein the item decoded or recognized audio is compared to the inventory items stored. More specifically, voice/audio is recognized as text, as known to those skilled in the art, and such text is searched to uncover user items (products) including such text. If there is a match at decision step 612, then execution proceeds to step 614 wherein the user is notified that a match has been made. This can be done via a light on sensor device 108 (202) or any other mechanism known to those skilled in the art. If there is a match at step 612, execution also proceeds to step 618 wherein the item is added to a user's grocery list. In this respect, the data item is assigned to the user's ID and stored along with the isle for such item. If however there is not a match, the user is also notified and execution proceeds to step 620. In addition, all matched and non-matched items are tracked and stored. The non-matched items may be counted to determine whether to add such items to the inventory of grocery items (codes) database 316. This is shown as steps 620 and 622. Execution proceeds to step 622 wherein the user items purchased are tracked and stored.

The ability to generate a user digital grocery store list quickly and efficiently is of great value to the user and such data is of value to a grocery store.

Example 1 (audio/sound detection). In practice, sensor device 108 (200) may employ two microphones and two processors. Microphone 1 senses sound and the processor 1 connected to it instructs processor 2 (host) to turn on microphone 2 connected to processor 2. Processor 2 then records the sounds received from microphone 2 and stores it in memory. Processor 2 simultaneously transmits a signal to central system 102 that processor 2 is in a recording state. Once recording is complete, processor 2 completes recording, processor 2 transmits a signal to central system 102 that recording is complete. Processor 2 performs voice to text functionality. The generated packets are then transmitted to central system 102 via WIFI network and Internet. Voice to text alternatively may be performed in central system 102 if desired.

Example 2 (item scanning). With the same components in example 1 above, proximity sensor senses an item/object and sends a signal to processor 2 (host). Processor 2 (host) activates sensor device 108 (200) for a period of time (e.g., 2.5 seconds). If a barcode is detected, the scanner will decode the bar code and transmit a numeric representation of that code (e.g., UPC) to processor 2. The code is then stored locally and transmitted to central system 102 in the cloud. The processor then deactivates the bar code scanner after the selected period of time.

In either example, sensor device 108 (200) incorporates automatic activation (turn-on) to enable efficient processing and ultimately energy conservation.

FIG. 7 depicts method steps of a grocery store in connection with the platform for sensing grocery items and generating a data list of the grocery items. In particular, execution proceeds from step 618 in FIG. 6 to steps 700 and 702 wherein the item list along with purchased items are transmitted to a user selected grocery store (upon registration or subsequently) and stored in central system 102. The transmission may be automatic or at the request of the user (e.g., for pre-order, pickup and/or delivery). The data items list is processed and analyzed. Central system 102 (platform 300) then determines (identifies) items purchased and not purchased items at steps 706 and 708.

The data analysis is valuable to grocery store operators (brick and mortar or online via website or application or API) so they can get achieve a more complete user basket. The end goal for an operator is to have the user purchase all of his/her items at the store. If operators are aware of a user's purchasing behavior habits, the operator can make strides increasing the time a user spends in a store and user purchases. The operator may offer users coupons for reduction in price of items on the user list but apparently not purchased at that store. In addition, the grocery stores will receive better pricing from manufacturers if the grocery store knows what to order and how much based on aggregated user data. Grocery store may make recommendations to a user to purchase a particular brand that store receives better profit margin. With a user's purchasing patterns, operators may offer promotional and marketing services to retailers and marketers for up-sales and cross-sales based on user lists, user's prior purchasing pattern/history and collaborative filtering. Examples appear below as follows.

(1) Platform 300 enables a retailer to promote a certain type of jelly to the mother who has peanut butter and bread on her list (cross-selling example for retailer based off what's on the user's current list).

(2) Platform 300 enables a marketer to promote new fruit snacks to the mom that buys Quaker granola bars often (cross-selling example for marketer based off what's on the user's current list).

(3) Platform 300 enables a marketer to promote new type of peanut butter to the mom that has Peter Pan peanut butter on her list (upsell example for marketer based off current list)

(4) Platform 300 enables a company to market new organic product to the health-conscious shopper who buys a lot of organic and gluten free products (cross-sell example for marketer based off purchasing history/patterns).

(5) Platform 300 is aware that a user buys chicken nuggets and ketchup. Other users also buy goldfish crackers and these new no sugar added fruit snacks are offered (upsell example for retailer or marketer based off collaborative filtering).

Platform 300 offers other benefits. Platform 300 offers enhanced list-making and purchasing services to users such as employing location data (e.g., geo-location) of user near or inside grocery stores to enable a user to easily access platform 300 on his/her mobile device. Platform 300 takes advantage of user-supplied preferences and/or historical data to help organize a data list of grocery items lists of a user's purchase history to add specific information to user-inputted plain data. For example, Beth tells sensor device 108 (200) to add milk but does not say the brand, quantity or size container. Platform 300 is aware from data analytics that Beth's history suggests that the only type of milk she buys is Blue Diamond Almond Milk, 32 ounces from Whole Foods. Platform 300 adds the correct type of milk to her Whole Foods grocery list. Platform 300 makes user data shopping lists based upon user's pre-determined preferences and/or shopping history. For example, if a user likes to order light bulbs and other household goods from Amazon.com and he likes to buy bulk food items like pasta from Walmart.com. When the user adds these items via sensor device 108 (200), the items are automatically routed to the correct lists within platform 300 (example of making list based off user-supplied preferences).

In addition to the above, platform 300 via an API (application interface) with e-commerce price data provider can supply users with price comparison tools. For example, a user has eggs, flour and light bulbs on his list, among other things. Platform 300 is configured to help the user make the decision to purchase light bulbs from Amazon.com and the rest of his items from grocery store. In addition to e-commerce price information, platform 300 is configured to employ the user's purchase preferences and/or history to suggest which items to purchase via e-commerce versus brick & mortar, thus optimizing the shopping process between different e-commerce and brick & mortar options. Platform 300 is configured to integrate via API as described above with e-commerce sites to employ the user's basket to purchase items in that basket that is on the user's list.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A method for providing a platform for sensing grocery items and generating a data list of the grocery items, the method comprising:
storing, in an item inventory database in a central system, a plurality of grocery items of an inventory and a plurality of codes associated with the plurality of grocery items of the inventory, respectively;
storing one or more lists of a grocery items of the user in a user list of grocery items database on the central system;
generating an ID associated with the sensor device;
sensing, by a sensor device, a grocery item and identifying a code associated with the grocery item, wherein sensing includes automatically activating the sensor device in response to a signal from a scan of the item or audio representing the item sensed;
comparing the code associated with the item to the plurality of codes stored in the item inventory database to determine if the item is matched to items in the item inventory database; and
storing the item in the user list of grocery items database as part of the user's list of grocery items if a match is determined.

2. The method of claim 1 wherein sensing includes detecting, by a barcode scanner within the sensor device, the item in proximity to the scanner.

3. The method of claim 1 wherein sensing includes sensing, by an audio sensor, sound from a user representing the item in proximity to the scanner.

4. The method of claim 1 further comprising tracking the stored items purchased by the user.

5. A system for providing a platform for sensing grocery items and generating a data list of the grocery items, the system comprising:
(a) one or more servers configured to store (i) an item inventory database of a plurality of grocery items of an inventory and a plurality of codes associated with the plurality of grocery items of an inventory of grocery items and (ii) a user list of grocery items database of one or more lists of a grocery items of the user; and
(b) a sensor device configured to sense a grocery item and identify a code associated with the grocery item, the sensor device further configured to automatically activate in response to signal from a scanner within the sensor device of the scanned grocery item or sound from a user representative of the grocery item;
wherein the one or more servers further configured to communicate with the sensor device, the one or more servers are programmed to execute method steps, the method steps comprising:
(1) generating an ID associated with the sensor device;
(2) comparing the code to the plurality of codes stored in the item inventory database to determine if the item is matched to items in the item inventory database; and
(3) adding the item to the user list of grocery items database as part of the user's list of grocery items if a match is determined.

6. The system of claim 5 wherein the method further comprising transmitting notice to a user if there is a match or a non-match.

7. The system of claim 5 wherein the method further comprises tacking grocery items purchased by the user.
